(19) United States
(12) Patent Application Publication
(10) Pub. No.: US 2013/0289752 A1
(43) Pub. Date: Oct. 31, 2013

(54) Method of Operating a Mobile Control Unit of a Home Automation Installation

(71) Applicants: Jean-Michel Orsat, Chatillon Sur Cluses (FR); Florent Pellarin, Pringy (FR)

(72) Inventors: Jean-Michel Orsat, Chatillon Sur Cluses (FR); Florent Pellarin, Pringy (FR)

(73) Assignee: SOMFY SAS, Cluses (FR)

(21) Appl. No.: 13/881,861

(22) PCT Filed: Oct. 25, 2011
(86) PCT No.: PCT/EP2011/068635

§ 371 Date: Jul. 3, 2013

(30) Foreign Application Priority Data
Oct. 26, 2010 (FR) 10 58766

(51) Int. Cl. G05B 11/01

(52) U.S. Cl. CPC G05B 11/01
USPC 700/90

(57) ABSTRACT

Method of operating a mobile control unit intended to form successively and alternately part: of a first home-automation installation, and of a second home-automation installation, characterized in that it comprises: a step of locating the mobile control unit in relation to the first home-automation installation and/or in relation to the second home-automation installation, a step of automatically selecting a common key in the mobile control unit, according to the result of the locating step.

The invention relates to the field of the control of home-automation appliances in several buildings comprising at least motorized appliances for closure or solar protection, for heating and air-conditioning, for lighting or for private swimming pool management.

These home-automation appliances communicate with one another with the aid of a home-automation network of radiofrequency type or by carrier currents, and can communicate with remote servers.

The invention is aimed at simplifying the control of these home-automation appliances, in particular when a user desires to use one and the same remote control within the framework of his main residence and within the framework of his secondary residence, or else when this user desires to transmit rights of access to one of his neighbors without however being compelled to provide him with a remote control. The invention also makes it possible to use a main residence remote control to access shared premises, for example a hotel room, and/or to control the appliances of these shared premises.

Patent application WO 03/088486 describes a near field evaluation method making it possible to ensure, when sending a pairing command, that a transmitter of this command is situated in immediate proximity to a receiver.

U.S. Pat. No. 7,724,687 envisages that a confidential datum such as a “house key” can only be sent from one commands transmitter to another commands transmitter if a commands receiver previously validates this transmission.

The patent application WO 03/081352 describes a method of change of common key while the U.S. Pat. No. 7,683,754 described a method for selecting a group for the transmission of a common key, for example by using the power supply voltage of the only elements of the group.

Patent application EP 1 967 923 describes a system and a method able to provide a user with an environment corresponding to a profile of preferences, this environment being modified through the detection of the presence of the user, for example by means of an electronic tag.

In patent application EP 1 482 718, the transmitter intended to establish the communication with the element to be controlled is hooked up to the mobile telephone by the earphone jack plug or by coupling and uses a DTMF or analogous modulation to transmit the coded signals from the mobile telephone to the transmitter.

Patent EP 0 913 979 also describes the supplementing of a mobile telephone with an additional transmitter for the remote control of an object. A specific mode allows remote control without use of mobile radiocommunication and the SIM subscriber code of the card is used as the user authentication means. The cellular structure of the mobile communication network is used as a possibility for controlling authentication.

Patent application US 2002/0031228 describes a mobile telephone able to communicate both with a public communication network of GSM type and, at short range, with Bluetooth devices, for example hotel room or rental vehicle locks. A connection between the mobile telephone and a remote server is ensured via the GSM network. The remote server transmits the Bluetooth authentication key to the mobile telephone, in encrypted form, decryptable by the mobile telephone. The Bluetooth authentication key is thereafter transmitted by the mobile telephone to the Bluetooth device by means of the Bluetooth transmitter. The user's personal identification code PIN can be used to make the transmission secure.

Application WO 00/57375 describes an antitheft security system for domestic electrical appliances. Each time the appliance is powered up, it operates only on receipt of a release code, transmitted by a house controller through the electrical power supply or a local network. Any appliance moved from its authorized position, that is to say not receiving its release code from the house controller, ceases to operate. It is envisaged that the house controller may itself be stolen at the same time as the domestic electrical appliance. To alleviate this drawback, the house controller comprises a means of location for example by way of a cellular network or by GPS and it can transmit its position to a remote operational center, by using for example the Internet or GSM network. The house controller does not have any other function in an installation than to ensure the disabling or the re-enabling of the appliances in the case of their disconnection and reconnection on the electrical network.

Patent application FR 2 924 890 describes a method for automatically selecting a peripheral such as a home-automation appliance using a proximity criterion: a message is broadcast to all the peripherals and each of them responds. As a function of the signal level received, the nearest peripheral is automatically pinpointed so as to dispatch a command to it.

U.S. Pat. No. 7,289,014 describes a system for controlling an access barrier such as a garage door or gate, especially as a function of the position and/or of the direction of motion of a vehicle in the vicinity of the access barrier. It is envisaged (FIG. 9) that particular locations of a transponder or “proximity device” can be trained with the aid of a GPS satellite location system, in such a way that the control system causes a predetermined action when the “proximity device” regains such a location, after training. For example, if the proximity device is in a so-called action location, then an action on a button causes an opening command, this not being the case outside of this action location.

Patent application WO 01/71685 describes a universal remote control and methods able to display on the screen of the remote control icons relating to the appliances within radio range of the remote control, and/or control interfaces of these appliances.

U.S. Pat. No. 6,563,430 describes a remote control device whose user control interface depends on the location of the control device, inside a house for example. Numerous location schemes are described.

U.S. Pat. No. 7,363,028 also describes this type of control device and especially a scheme for radiofrequency identification of the appliance nearest to the control device, by progressive decay of the transmission power. This device is used for the control of various HiFi appliances in a room.

U.S. Pat. No. 7,110,761 describes the use of a directional pointing device to establish a wireless connection between the pointing device and another device, targeted by the directional pointing device.

In these last three documents, no reference is made to a common key, shared between the appliances to be driven and a remote control and making it possible especially to secure a function for accessing the building.

The aim of the invention is to provide a method of operating a mobile control unit remedying the drawbacks mentioned previously and improving the methods known from the prior art. In particular, the invention proposes a secure operating method in which it is possible to control in a simple and user-friendly manner by virtue of a mobile control unit, such as a portable telephone or a simple keyring remote control, various appliances of several distinct home-automation installations, and in particular of the access appliances of these distinct home-automation installations.

According to the invention, the method governs the operation of a mobile control unit intended to form successively and alternatively part:
of a first home-automation installation comprising appliances communicating on a first home-automation network, each element of the first installation being provided with an identifier and sharing one and the same first common key specific to the first home-automation network and authenticating an appliance's membership of the first home-automation network, and
of a second home-automation installation comprising appliances communicating on a second home-automation network, each element of the second installation being provided with an identifier and sharing one and the same second common key specific to the second home-automation network and authenticating an appliance's membership of the second home-automation network, the mobile control unit comprising a memory containing several common keys, which include the first and second common keys, characterized in that it comprises:
   a step of locating the mobile control unit in relation to the first home-automation installation and/or in relation to the second home-automation installation,
   a step of automatically selecting a common key in the mobile control unit, according to the result of the locating step.

At least one of the appliances of the first installation can be a motorized closure appliance and/or at least one of the appliances of the second installation can be a motorized closure appliance.

The locating step can comprise the comparing of geolocation data for the mobile control unit with a contour recorded in a cartographic memory.

The locating step can comprise the reception by the mobile control unit of a response of at least one of the home-automation appliances to a message dispatched by the mobile control unit.

The operating method can comprise a step of transmitting a first message, comprising a response request, by the mobile control unit and a step of transmitting a second message by each appliance that received the first message.

One of the transmission steps can be carried out at reduced power.

The operating method can comprise a step of transmitting a third message comprising a control command and the first common key and a step of transmitting a fourth message comprising the same control command with the second common key when the third message has not given rise to any response picked up by the mobile control unit.

The locating step and/or the automatic selection step can be deactivated provided that a common key has been selected.

The locating step and/or the automatic selection step is reactivated provided that a transmitted order does not give rise to a response of a home-automation appliance.

The operating method can comprise a step of securely transmitting the first and second common keys and of recording these common keys in the mobile control unit.

The operating method can comprise a step of downloading into the mobile control unit a table of the identifiers of home-automation appliances which are able to be controlled by the mobile control unit.

The secure transmission step or the downloading step can be performed on the basis of data situated in a remote server.

The step of locating the mobile control unit can comprise the locating of the mobile control unit in relation to a first geographical zone containing the elements of the first home-automation installation and/or the locating of the mobile control unit in relation to a second geographical zone containing the elements of the second home-automation installation.

According to the invention, a mobile control unit comprises hardware and/or software means for implementing the above-defined operating method.

According to the invention, an installation comprises a mobile control unit defined above.

The invention also pertains to a computer program comprising a computer program code means suitable for carrying out the steps of the above-defined method, when the program is executed on a computer.

The invention will be better understood on reading the description which follows, given solely by way of example while referring to the appended drawings in which:

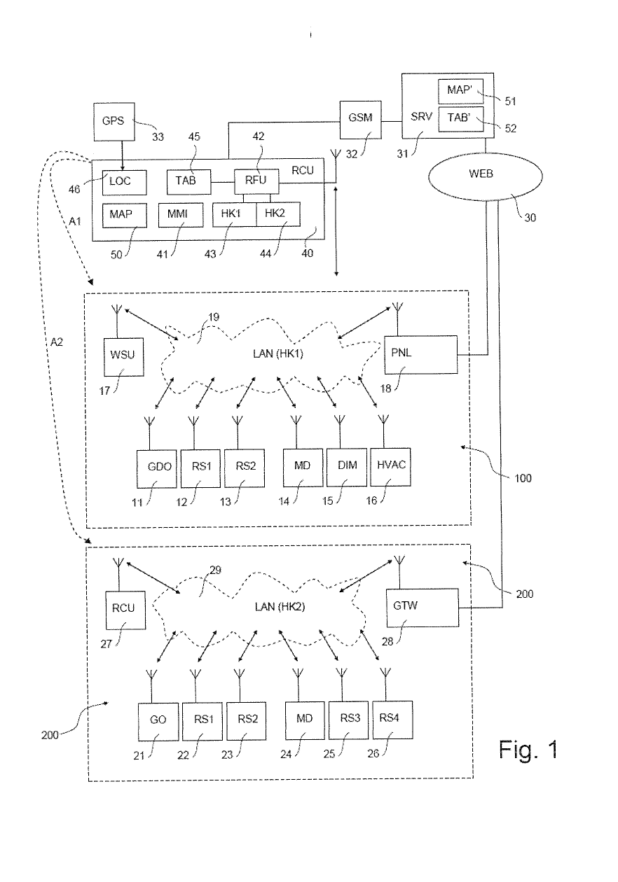

FIG. 1 represents in the form of a functional diagram two home-automation installations and a mobile control unit according to the invention.

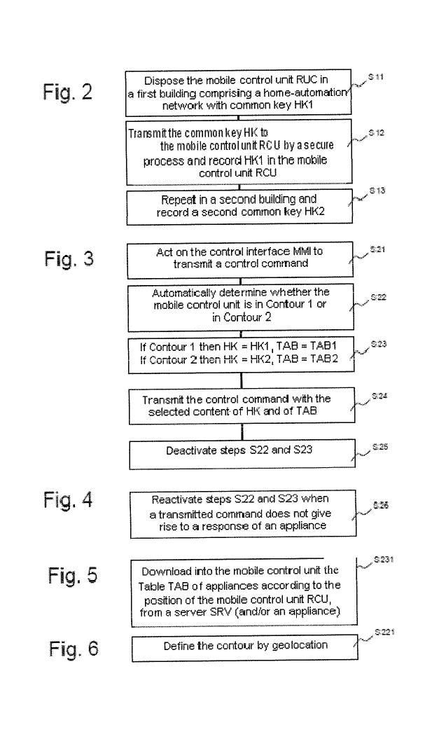

FIG. 2 represents preliminary steps of the various modes of execution of the operating method according to the invention.

FIG. 3 represents main steps of a first mode of execution of an operating method according to the invention.

FIG. 4 represents a step complementary to a second mode of execution of an operating method.

FIG. 5 represents a sub-step of a third mode of execution of an operating method.

FIG. 6 represents a first mode of implementation of a step of the first mode of execution of an operating method.

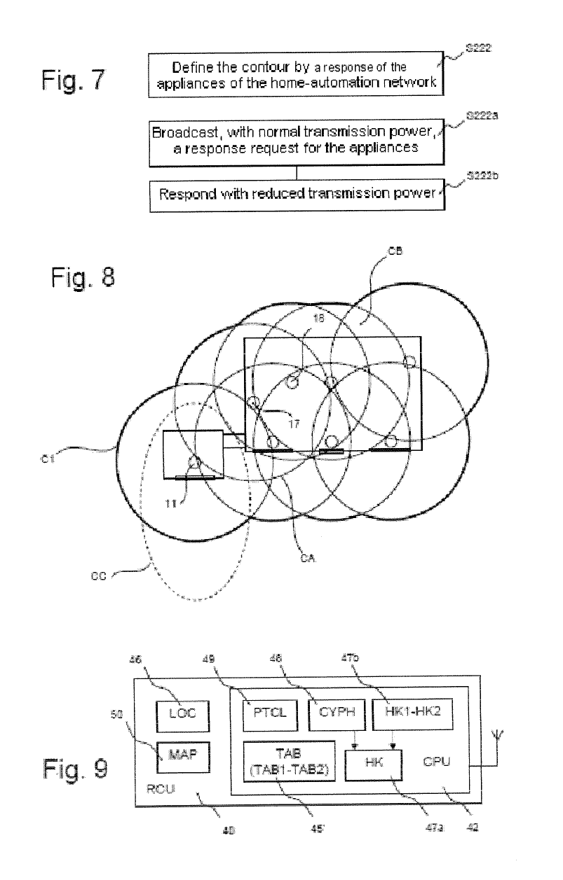

FIG. 7 represents a second mode of implementation of a step of the first mode of execution of an operating method.

FIG. 8 represents a geographical zone used in the second embodiment of the step represented in FIG. 7.

FIG. 9 partially represents the mobile control unit so as to illustrate embodiment details.

FIG. 1 represents in the form of a functional diagram a first home-automation installation 100, a second home-automation installation 200 and a mobile control unit 40 according to the invention. The figure also represents the links of the home-automation installations and of the mobile control unit with the environment.

The home-automation installations comprise appliances. Certain appliances are of actuator type and comprise in particular one or more electric actuators. Other appliances are of sensor type or of control box type. Thus, in the example of FIG. 1, the first installation comprises:
a first appliance 11 of actuator type for a garage door,
a second appliance 12 of actuator type for a roller blind,
a third appliance 13 also of actuator type for a roller blind,
a fourth appliance 14 of actuator type for an electric lock for a main door,
a fifth appliance 15 of dimmer actuator type for a variable-intensity lighting device.
a sixth appliance 16 of heating/air-conditioning actuator type,
a seventh appliance 17 of control box and sensor type, in the form of a wall switch,
an eighth appliance 18 of control box and sensor type including a display screen, a tactile control interface and including for example a temperature probe.

Of course, the home-automation installation can comprise a much higher number of control boxes and/or sensors and can comprise other appliances in addition to or in replacement for the above-listed appliances, especially appliances of actuator type for terrace awnings, water treatment, ventilation, etc., including of domestic type such as a washing machine, a television etc. The invention applies however preferably to appliances occupying a fixed place in the building and at least one of the appliances being of access type, that is to say able to prevent an intrusion, this being the case here for the first four appliances.

All the appliances communicate with one another on one and the same first home-automation network 19, of local type (LAN) and using a common protocol, for example io-homecontrol, EIB, Zigbee etc. (trademarks). Preferably, the home-automation network is of radiofrequency type, this being represented by bidirectional arrows and an antenna symbol on each appliance. Alternatively, several local networks of different protocol and/or media are used to form the first home-automation network 19. The appliances therefore each comprise a linking means allowing communication in the home-automation network 19.

All the appliances share a first common key HK1, termed a house key. This key is for example a word of 64 or 128 bits, accommodated in a memory of each appliance and an authentication algorithm using the common key is used to allow an appliance to recognize that a control command or an arbitrary message has indeed come from another appliance of the installation.

Hereinafter, for simplicity, a message will be said to “contain the common key” or “comprise the common key” when its transmitter is authenticated by the common key. In practice, this authentication is carried out by dialog between the transmitter of the message and its recipient, or is carried out by encryption of the content of the message with the aid of the common key, or else requires both dialog and encryption of the content of the message. The common key is therefore not contained, as such, in the messages.

Preferably, the installation is hooked up to a remote server. Thus, the eighth appliance 18 can be connected to a shared network 30 of Internet type by a gateway, not represented. A remote server 31 can also be connected to the shared network, thus permitting communication between the eighth appliance and the remote server, or communication between any appliance and the remote server, by successively using the local network and the shared network.

In the same manner, a second home-automation installation 200 comprises several home-automation appliances referenced 21-26, the latter here being of access type and consisting respectively of a motorized gate 21, two roller blinds 22-23, a main door lock 24 and two other roller blinds 25-26.

These home-automation appliances communicate on a second home-automation network 29, using the same protocol as the first home-automation network. A second common key HK2 is shared by all the appliances of the second home-automation network. The second home-automation installation also comprises a remote control unit 27 of nomadic type, able to communicate on the second home-automation network, and a communication gateway 28 between the second home-automation network and the shared network 30.

The first home-automation installation corresponds for example to the user's main residence, while the second home-automation installation corresponds for example to his secondary residence.

Alternatively, the second home-automation installation corresponds for example to the main residence of a neighbor.

Alternatively, the second home-automation installation is a hotel room.

A mobile control unit 40 comprises a means of network linking to the first home-automation network 19 and to the second home-automation network 29, this network linking means also being represented by the symbol of an antenna and a double arrow.

Thus, the same mobile control unit can participate in the control of the first installation, as represented by the arrow A1, or in the control of the second installation, as represented by the arrow A2.

The mobile control unit comprises a control interface 41, for example a keypad with two or four buttons when the mobile control unit exhibits reduced dimensions so as to serve as a keyring and/or be easily inserted into a pocket or a handbag.

Alternatively, the control interface comprises a more sizable keypad and display means, or else a touchscreen.

The mobile control unit comprises a home-automation communication unit 42 able to transmit messages sent on the home-automation network in the form of radiofrequency signals by the linking means. These messages comprise the control orders resulting from an action on the man machine interface as well as the common key of the first installation or of the second installation. The home-automation communication unit is hooked up to a memory of first common key 43 and to a memory of second common key 44. The home-automation communication unit is also hooked up to a table 45 including the identifiers of the appliances able to be controlled by the mobile control unit.

These elements may be brought together in one and the same microcontroller.

The mobile control unit comprises a location means 46. The location means 41 preferably uses an external resource 33, for example geolocation satellites of GPS or Galileo type.

The location means can also comprise an accelerometer, especially a 3D accelerometer, to establish a part of a location information. Advantageously, one and the same 3D accelerometer is used in the location means, for measurements of displacement with respect to a reference point and in the orientation measurement means for measurements of orientation of the mobile control unit.

The mobile control unit is moreover linked to the server 31 by a long-distance communication network 32, of GSM type.

A portable telephone equipped with the hardware means described hereinabove and with software means able to execute the methods described subsequently can advantageously serve as mobile control unit. The means of network linking to the home-automation network is for example accommodated in the SIM card of the telephone, or in the battery of the telephone, or it is linked to the telephone by a removable connection, such as an earphone “jack” plug or “dock” or a support plug (termed a “dock” plug). The home-automation communication unit is detailed in this variant under the reference 42 in FIG. 9: it comprises an active common key memory 47a in which is recorded the active common key and a table of common keys 47b, containing the codes of all the common keys recorded in the mobile control unit. Alternatively, the active common key memory can consist of a pointer indicating where the active common key is situated in the table of common keys.

The home-automation communication unit also comprises an encryption key 48 and, in permanent memory 49, the protocol PTCL of the home-automation network.

For security reasons, the command unit is a piece of hardware distinct from the telephone, with which it is associated to form the mobile control unit, and can only be provided for example by a manufacturer of one of the appliances of the home-automation network. This distinctive character of the command unit appears in the form of a bold line.

The control unit comprises hardware and/or software means making it possible to govern its operation in accordance with the method which is the subject of the invention. The software means can especially comprise a computer program code means suitable for carrying out the steps of the method according to the invention, when the program runs on a computer. The hardware means comprise a location means making it possible to locate the mobile control unit with respect to one or more geographical zones, in particular two geographical zones containing respectively the elements of the first and of the second home-automation installation and a means for automatically selecting a common key contained in the mobile control unit.

FIG. 2 represents preliminary steps of the various modes of execution of the operating method according to the invention. In a first preliminary step S11, the mobile control unit is disposed in the building containing the first home-automation installation or in the environs of this building.

Subsequent to a particular maneuver of the user, a second preliminary step S12 is activated, in which the first common key HK1 is transmitted to the mobile control unit.

This step uses one of the methods known from the prior art. It may have been delegated to a trusted installer.

For example, the common key is contained in a confidential document communicated to the installer by the owner of the installation. It is then entered, in the form of alphanumeric characters, with the aid of a keypad of the mobile control unit. Alternatively, it is inscribed in barcode form on the confidential document and it is read by a photographic apparatus of the mobile control unit. Alternatively, it is recorded in an electronic tag possessed by the owner and transmitted to the installer by the latter, the mobile control unit being able to read said electronic tag. Alternatively, it is transmitted via GSM by the remote server. Alternatively, it is transmitted, at reduced power, on the home-automation network by an appliance internal to the building and on which a particular manipulation has been carried out. Several of these alternatives can be combined to transmit all or part of the common key to the mobile control unit.

Preferably, the securing of the process comes from an encryption and an authentication procedure: for example a PIN code known only to the owner, or only to the installer, makes it possible to decrypt the common key.

The first common key is then recorded in a memory of the mobile control unit, and preferably in a separate module RFU of this mobile control unit, described in conjunction with FIG. 9, the decryption taking place in this separate module.

In a third preliminary step S13, the previous steps are repeated for the second installation and the second common key.

On completion of the preliminary steps, which can take place in an arbitrary order of the installations and according to an arbitrary calendar, the two common keys are recorded in the mobile control unit.

These preliminary steps can be repeated for a third installation or a more sizable number of installations if the number of common-key memories has been envisaged accordingly.

Preliminary sub-steps, not described, have also made it possible to record the identifiers of the appliances able to be controlled by the mobile control unit in each installation.

FIG. 3 represents main steps of a first mode of execution of the operating method. The operating method can be used both in a usage mode and in a configuration mode.

This operating method is activated provided that more than one common key has been recorded in the mobile control unit. It is assumed in what follows that the mobile control unit, contained for example in a keyring, is used by a user who is the owner of a main residence (first installation) and of a secondary residence (second installation).

In a first main step S21, the user acts on the control interface to transmit a control command. For example, he has left his main residence and arrives in the vicinity of his secondary residence: he then presses the control button that he knows to be assigned to the gate actuator 21. There is then passage to a second main step S22, termed the locating step, in which the mobile control unit is located. Locating is performed by determining whether the mobile control unit is situated in a first geographical zone, covering the first installation, or a second zone, covering the second installation. Each zone is defined by a contour. A first contour (Contour 1) therefore corresponds to a first geographical zone in which the first installation is situated and a second contour (Contour 2) corresponds to a second geographical zone in which the second installation is situated. The locating of the mobile control unit in one zone or the other can be performed according to several schemes, described subsequently.

In a third main step S23, termed automatic selection, the first common key HK1 or the second common key HK2 is chosen as common key HK depending on whether this location corresponds to the first installation or to the second installation. The same holds for the choice between a first set of identifiers TAB1 or a second set of identifiers TAB2.

Thus, in a fourth main step S24, a control command is transmitted by the mobile control unit, this command comprising both the appropriate common key and the identifier corresponding to the appliance designated by the action on the control interface.

Hereinafter, in a fifth main step S25, there is automatic deactivation of the second and third main steps, these having become needless as long as there is no change of installation. Thus, the mobile control unit behaves subsequently as if it were assigned solely to the second installation, thereby avoiding any loss of time, any needless radio traffic and any needless consumption in the execution of the next commands.

Alternatively, only the third main step is deactivated, and will be reactivated only if the locating step shows that the location corresponds to a change of installation.

FIG. 4 represents a second mode of execution of the operating method, distinguished from the first mode of execution in that it comprises in addition a complementary step or sixth main step S26, in which there is automatically reactivation of the second main step and of the third main step, in the case where the transmission of a command does not give rise to any response. The absence of response may indeed result from the fact that the user has left his secondary residence and is once again in front of his main residence, no appliance of which responds to a message transmitted with the second common key HK2. There is therefore reason to reinstate a step of automatically determining the location of the mobile control unit.

FIG. 5 represents a third mode of execution of the operating method, distinguished from the first mode of execution in that the third main step comprises a sub-step S231. This sub-step comprises a downloading of the table of the set of identifiers of the installation which has just been determined and which can be controlled on the basis of the mobile control unit. Thus, the memory capacity of the mobile control unit assigned to the recording of a set of identifiers can be reduced, and limited to the maximum number of identifiers contained in an installation and/or liable to be controlled by the mobile control unit. For example, a remote control with 4 buttons can have a memory space limited to 4 identifiers (excluding identifiers obtained by combined pressing of various buttons).

The downloading can be done on the basis of data stored in a remote server, or stored in one of the appliances of the installation, preferably a fixed appliance, for example the control box 18 of the first installation and the gateway 28 of the second installation.

If the data are stored in a remote server, they can be transmitted via the GSM communication network or via the shared network. These data identifying the appliances do not require the same degree of security as the common keys.

FIG. 6 represents a first mode of implementation of the second main step S22 of the first mode of execution of the operating method, in the form of a single step S221, applicable when the mobile control unit comprises a geolocation resource, for example in the case of a telephone. In this single step, the contour is defined by geolocation. Stated otherwise, the position of the mobile control unit is determined with the aid of the location means, for example by use of location signals coming from satellites such as GPS signals, and this position is compared with a contour prerecorded in a cartographic memory. The position determination can take place in this case in a manner independent of any other action, that is to say the second main step and the third main step can then precede the first main step.

The locating step takes place preferably in the mobile control unit, the latter comprising a first cartographic memory 50 in which have been stored (during a prior configuration step) position coordinates of each installation, from which the contour relating to each installation is deduced.

For example, the contour of an installation is defined on the basis of the geographical coordinates of the two remotest appliances of the installation and corresponds to the quadrilateral defined by the intersection of the straight lines:

x=XMIN−20, x=XMAX+20

with the straight lines:

y=YMIN−20, y=YMAX+20

XMIN, XMAX, YMIN and YMAX representing the extremes of the geographical coordinate values recorded in the cartographic memory for these remote appliances and a value of 20 meters being chosen as margin to delimit the contour.

Alternatively, this locating step can be executed in part in the remote server, the latter being able also to contain a second cartographic memory 51, containing the geolocation data for the contours of each installation.

In this case, the second step S22 can comprise the dispatching by the mobile control unit of the position information to the remote server, using the GSM communication network, and in receiving the result from the remote server, for example in the form of one of the three results:
R1: Location=Installation_1
R2: Location=Installation_2
R3: Location=Out of range of Installations

FIG. 7 represents a second mode of implementation of the second main step S22 of the first mode of execution of the operating method. In this case, the locating step takes place in the form of a determination step S222 based on the response of the appliances of the home-automation network to a control command comprising either the first common key, or the second common key. Firstly, the current common key, or initial common key, is used. If no response is picked up by the mobile control unit, then it deduces therefrom that it is necessary to use the other common key to repeat the same order. If a response is then obtained, this other common key is henceforth taken as the new common key in replacement for the initial common key. Otherwise, this signifies that he is outside the radio range of each of the two installations, so the initial common key is retained, since it is more probable that the user will subsequently return to the last residence used rather than change residence. Alternatively, the common key memory HK can be emptied.

For example, the mobile control unit is a remote control of keyring type comprising 4 control buttons. Each control button is dedicated to an appliance, to control it according to a two-stage cycle (start-stop) or according to a 4-stage cycle (direction 1—stop—direction 2—stop) depending on the type of appliance. One of the control buttons is assigned to the garage door (reference 11) in the first installation and is assigned to the gate (reference 21) in the second installation.

It is assumed that the garage door actuator is defined by the identifier ID(11) in the first table of identifiers TAB 1, and that the gate actuator is defined by the identifier ID(21) in the second table of identifiers TAB2. The mobile control unit is used a last time to close the garage door of the first installation, at the moment when the user leaves his main residence. When he arrives in proximity to his secondary residence, he activates the same control button to dispatch an order to open the gate.

However, the message transmitted by the mobile control unit comprises the code of the first common key HK1 and the identifier ID(11). This order does not therefore receive any response. Therefore, the message is re-transmitted, but this time contains the code of the second common key HK2 and the identifier ID(21).

This order therefore causes an acknowledgment of receipt, and is then executed. The receipt of an acknowledgment of receipt suffices to indicate to the mobile control unit which is its new location, and thus terminates the locating step.

The method then passes to the third main step S23, and the second common key HK2 becomes the new common key for all the orders which will follow, at least as long as these orders give rise to a response on the part of the appliances.

This second mode of implementation can lend itself equally well to a larger number of common keys. It should be noted that the dispatching of successive messages by the control unit until an acknowledgment of receipt is obtained can be completely masked for the user since these exchanges can occur in a few tenths of a second, or indeed less, that is to say for example while he is pressing the control button.

In order to make the common key toggling procedure secure, the determination step S222 can be split into two sub-steps, also represented in FIG. 7, so as to be certain of the location of the mobile control unit. In a first sub-step S222a, a response request is broadcast, with no indication of recipient home-automation appliance identifier, by using the initial common key. All the appliances using this common key, which pick up this request, respond with an acknowledgment of receipt, transmitted at reduced power. If this response is picked up by the mobile control unit, the common key is then retained. Otherwise, the other common key is used to repeat the same sub-steps, and it is this key which will be retained if at least one response is obtained from an appliance.

Alternatively, and more simply, the broadcast message is transmitted at reduced power during the first sub-step S222a and the response message is transmitted at normal power during the second sub-step S222b.

FIG. 8 represents a contour C1 used in this second mode of implementation, assuming that the range, which is for example 300 meters in free field, reduces to 10 meters when one of the transmissions takes place at reduced power.

Thus, the mobile control unit ceases to be within range of at least one of the appliances immediately upon leaving the first contour C1, formed by the envelope of circles of radius 10 meters centered on each of the appliances. For example the circle CA is centered on the appliance referenced 17 and the circle CB is centered on the appliance referenced 18.

Each circle corresponds to the locus of the limit points of communication between the appliance and the mobile control unit. When an appliance exhibits directionality, the circle is replaced with a radiation pattern of substantially elliptical type as represented by dashes under the reference CC for a radiation pattern of the reference appliance 11.

The range value is chosen sufficient for there to be overlap of the circles or radiation patterns and to obtain a single contour containing the set of appliances of the installation.

If the home-automation communication unit of the mobile control unit does not receive any response to the message broadcast during the first sub-step S322, then the mobile control unit RCU is outside the first contour C1, and the second main step of the method is activated with another common key to determine whether the mobile control unit is situated in another contour.

The benefit of defining a dimensionally relatively restricted contour is to make it possible to apply the control method to installations that are close together, for example to several similar installations of a development or condominium.

For example, at the request of the owner of a first house and under his command, a mobile control unit of a home-automation installation of a neighboring house can receive, as was indicated above, both the common key of the first house and the identifiers of certain appliances, especially of access type, that the owner desires to make available to the neighboring house, for example in his absence to profit from certain installations (swimming pool) or to allow the delivery of goods.

The person to whom this neighboring house remote control is available is in no way inconvenienced by this transfer of new rights since the operation of his remote control remains strictly identical in his neighboring house. On the other hand, at the moment at which this remote control is used to access the first house, it automatically adopts the configuration able to control the authorized appliances of the first house.

This results in great ease of use, a cost reduction since there is no need to purchase an additional remote control, a decrease in the risks of loss or theft of the access means, since the rights are transferred to a nomadic object of which the person to whom it is available takes particular care since it is the remote control for access to his own house, the neighboring house.

The right to use the common key of the first house is preferably conditioned by a determined period or by a particular event.

In another exemplary application, the rights of access to a hotel room are transferred to the mobile control unit, in a secure manner and for a determined period, in the form of a transfer of the common key relating to this hotel room and in the form of a table of identifiers of the appliances of the hotel room. All the preferences of the owner of the mobile control unit may have been recorded, or be communicated by a remote server, so as to greet him with his customary environment.

Alternatively or in a manner complementary to what has just been described, a transmission power indicator signal (known as “Received Signal Strength Indicator”—RSSI) can be used in the steps of locating and/or of selecting one of the common keys, especially to cope with the case where two installations are sufficiently neighboring for there to be overlap of the ranges, including when the transmission is carried out at reduced power. In this case, a variant of the second and third main steps consists in broadcasting a first interrogation message with the first common key and in recording a first value corresponding higher RSSI level of the responses, and then in repeating the same operation with the second common key and in likewise recording a second value. The selection of the common key is carried out by taking the one that gave the highest value. Alternatively, the first value and the second value correspond to a mean value of the RSSI levels received in each case.

Barring technical or logical incompatibility, the various modes of execution of the operating method can be combined together. Likewise, barring technical or logical incompatibility, the various modes of implementation of the steps can be applied to the various modes of execution and to the various combinations of the modes of execution.

1. A method of operating a mobile control unit intended to form successively and alternatively part:
of a first home-automation installation comprising appliances communicating on a first home-automation network, each element of the first installation being provided with an identifier and sharing one and the same first common key specific to the first home-automation network and authenticating an appliance's membership of the first home-automation network, and
of a second home-automation installation comprising appliances communicating on a second home-automation network, each element of the second installation being provided with an identifier and sharing one and the same second common key specific to the second home-automation network and authenticating an appliance's membership of the second home-automation network, and
the mobile control unit comprising a memory containing several common keys, which include the first and second common keys, wherein the method comprises:
a step of locating the mobile control unit in relation to the first home-automation installation and/or in relation to the second home-automation installation,
a step of automatically selecting a common key in the mobile control unit, according to the result of the locating step.

2. The operating method as claimed in claim 1, wherein at least one of the appliances of the first installation is a motorized closure appliance and/or at least one of the appliances of the second installation is a motorized closure appliance.

3. The operating method as claimed in claim 1, wherein the locating step comprises the comparing of geolocation data for the mobile control unit with a contour recorded in a cartographic memory.

4. The operating method as claimed in claim 1, wherein the locating step comprises the reception by the mobile control unit of a response of at least one of the home-automation appliances to a message dispatched by the mobile control unit.

5. The operating method as claimed in claim 4, wherein the method comprises a step of transmitting a first message, comprising a response request, by the mobile control unit and a step of transmitting a second message by each appliance that received the first message.

6. The operating method as claimed in claim 5, wherein one of the transmission steps is carried out at reduced power.

7. The operating method as claimed in claim 4, wherein the method comprises a step of transmitting a third message comprising a control command and the first common key and a step of transmitting a fourth message comprising the same control command with the second common key when the third message has not given rise to any response picked up by the mobile control unit.

8. The operating method as claimed in claim 1, wherein the locating step and/or the automatic selection step is deactivated provided that a common key has been selected.

9. The operating method as claimed in claim 8, wherein the locating step and/or the automatic selection step is reactivated provided that a transmitted order does not give rise to a response of a home-automation appliance.

10. The operating method as claimed in claim 1, wherein the method comprises a step of securely transmitting the first and second common keys and of recording these common keys in the mobile control unit.

11. The operating method as claimed in claim 1, wherein the method comprises a step of downloading into the mobile control unit a table of the identifiers of home-automation appliances which are able to be controlled by the mobile control unit.

12. The operating method as claimed in claim 10, wherein the secure transmission step or the downloading step is performed on the basis of data situated in a remote server.

13. The operating method as claimed in claim 1, wherein the step of locating the mobile control unit comprises the locating of the mobile control unit in relation to a first geographical zone containing the elements of the first home-automation installation and/or the locating of the mobile control unit in relation to a second geographical zone containing the elements of the second home-automation installation.

14. A mobile control unit comprising hardware and/or software means for implementing the operating method as claimed in claim 1.

15. An installation comprising a mobile control unit as claimed in claim 14.

16. The operating method as claimed in claim 11, wherein the secure transmission step or the downloading step is performed on the basis of data situated in a remote server.
